(19) United States
(12) Patent Application Publication
(10) Pub. No.: US 2004/0049556 A1
(43) Pub. Date: Mar. 11, 2004

(54) Communication apparatus

(76) Inventor: Kenichi Watanabe, Yamatokoriyama-shi (JP)

Correspondence Address: BIRCH STEWART KOLASCH & BIRCH, PO BOX 747, FALLS CHURCH, VA, 22040-0747, US

(21) Appl. No.: 10/658,766

(22) Filed: Sep. 10, 2003

(30) Foreign Application Priority Data
Sep. 11, 2002 (JP) P2002-265943

(51) Int. Cl. G06F 15/16

(52) U.S. Cl. 709/217

(57) ABSTRACT

An I-FAX apparatus has the function of performing facsimile communications in connection with the Internet, and it can operate as a master set and use a slave set. A detachable manipulation panel section has some of the manipulation keys of a facsimile body, dial keys and a display device, and it is separable from the facsimile body. The detachable manipulation panel section, the slave set, and storage devices of portable type such as IC memory cards function as portable storage devices which are units being separable or separate from the facsimile body. The I-FAX apparatus can be utilized by storing Internet information items for each individual person in the portable storage devices. Each of the storage devices of portable type can be furnished with dial keys, manipulation keys and a display device, and it permits the user to display and edit the information independently of the facsimile body, etc.

### BACKGROUND OF THE INVENTION

1. Field of the Invention

The present invention relates to a communication apparatus or an information processing apparatus connectable to the Internet, such as Internet facsimile apparatus.

2. Description of the Related Art

There has heretofore been employed an operating system (OS) of multiuser type which permits a plurality of users to separately use an information processing apparatus such as computer. With such an operating system, the procedures of log-in and log-out need to be performed by setting a password or the like every user.

In communication apparatuses such as telephone sets and facsimile apparatuses, there has already been disclosed a communication apparatus or method wherein personal information items are stored in a portable storage device, such as magnetic card or memory card, for individual originating persons, whereby a plurality of users use the communication apparatus jointly with security ensured from one another. With such a method, the procedures of log-in and log-out are unnecessary.

Japanese Unexamined Patent Publication JP-A 60-116259 (1985) discloses a method wherein a portable storage device for storing personal information is employed, whereby an autodialing or short dialing code which a user has set can be used at any of terminal devices. The portable storage device, for example, a magnetic card stores therein a person recognition code or the autodialing or short dialing code set by the owner. The magnetic card is attached to the terminal device such as autodialing device or telephone set, so as to input the contents of the magnetic card to the terminal device. Thus, no matter which of the terminal devices may be employed, the owner of the magnetic card can call up an opposite party by manipulating the terminal device with the autodialing or short dialing code which he/she has set.

Japanese Unexamined Patent Publication JP-A 63-108849 (1988) discloses a portable, personal communication recording medium such as card magnetic recording medium, in which information items required by an individual are stored and which is detachably attached on a communication terminal device. Owing to the personal communication recording medium, information items having heretofore been stored in a telephone set can be managed in a manner to be separated from the telephone set. The information items required by the individual, such as a name, a telephone No. and a message to an opposite party, are stored in the personal communication recording medium by key inputs. Subsequently, when the personal communication recording medium is connected to an interface on the side of the telephone set, this telephone set automatically calls up the opposite party, reads out the message and transmits the message to the opposite party in accordance with the information items stored in the personal communication recording medium. Thereafter, when the interface recognizes the reception of a message from the opposite party, it writes the received message into the personal communication recording medium.

Japanese Unexamined Patent Publication JP-A 1-137767 (1989) discloses a telephone set with a memory card, wherein a necessary memory portion is afforded by the memory card, and the telephone set proper is endowed with a circuit arrangement adapted to cope with the memory card which is detachably attached. The telephone set incarnates such functions as short dialing, and recording and playback of conversational voices.

Japanese Unexamined Patent Publication JP-A 8-84197 (1996) discloses a system wherein an information communication card which is portable is employed so that the optimal communication network required by a user may be automatically selected for communications, whereby the user can efficiently utilize various information communication networks or communication services without being conscious of them.

Japanese Unexamined Patent Publication JP-A 8-97852 (1996) discloses a mobile mail system which is so constructed that a single mobile terminal, for example, PDA (personal digital assistant) can be shared by a plurality of users, and that each of the users having set desired reception conditions can automatically acquire electronic mail from a mail server irrespective of times and places. The user stores information for the grant of access to the mail server, the mail reception conditions, etc., in the secure storage area of an IC card, and he/she possesses the IC card and mounts it on the PDA in using the system. After the PDA has authenticated the user by reading out personal information from the IC card, it updatably registers the mail reception conditions in the mail server. The mail server monitors the reception of any electronic mail meeting the conditions, by a mail reception monitoring unit and a condition deciding process unit, and it automatically transmits the header information of the electronic mail upon the reception. When the transfer of the electronic mail to a FAX or the like is designated, the mail server executes the transfer.

Japanese Unexamined Patent Publication JP-A 10-51349 (1998) discloses a portable communication apparatus wherein a storage unit adapted to individually manage a plurality of personal Nos. and the information items of a plurality of persons is disposed, whereby the plurality of users can use the communication apparatus with settings corresponding to the respective users.

Japanese Unexamined Patent Publication JP-A 10-283292 (1998) discloses a portable storage medium allotted to each person and for use in terminal devices connected to a network, which can store personal identification information, electronic-mail-operating-environment setting information, electronic-mail-storage-area designating information, electronic mail created for transmission, and received electronic mail, and in which personal mail items can be accumulated by the function of an additional program for altering a mail environment.

Japanese Unexamined Patent Publication JP-A 2000-330904 (2000) discloses a terminal device with a network communication function, characterized by comprising a loading section for an external memory, and network communication function executing means for reading out information items required in utilizing the network communication function, such as ISP (Internet Service Provider) information and user's mail account information which are stored in the external memory loaded in the loading section, and for executing the accesses of the transmission and reception of the network communication function by using the read-out information items and also storing data received by network communications, in the external memory, whereby any user is permitted to utilize the network communication function, for example, electronic mail function of the single terminal device, through a simple manipulation.

Even in the related-art techniques mentioned above, the management of the information items of each person has already been made for the plurality of users who use the communication apparatus or the like in common. However, in a communication apparatus or an information processing apparatus connectable to the Internet, such as Internet facsimile apparatus, the information items of each person concerning the Internet cannot be managed, and a picture cannot be stored therein, either.

In a multiuser operating system which requires log-in and log-out procedures, security can be ensured among users as long as passwords, etc. are appropriately managed, but the administrator of the system can access all information items.

In the communication apparatuses such as telephone sets and facsimile apparatuses, there have already been disclosed the communication apparatus or method wherein the personal information items are stored in the portable storage device, such as magnetic card or memory card, for the individual originating persons, whereby the plurality of users use the communication apparatus jointly with the security ensured from one another, and the communication apparatus or method wherein each user selects any of the plurality of terminal devices and mounts the portable storage device storing the personal information, on the selected terminal device, whereby any of the terminal devices can be used in the same environment.

In any of the communication apparatuses or methods, however, the storage device does not function in a state where it is detached from the communication apparatus, and it needs must be attached to the communication apparatus for the purposes of the verification, revision, new input, etc. of the contents.

### SUMMARY OF THE INVENTION

An object of the invention is to provide a communication apparatus of multiuser type, in which information items on the Internet are stored for each individual person, which can be easily utilized, which can reliably keep secrets among the users, and which can be used by each of the users as if it were an apparatus dedicated to him/her.

The invention provides a communication apparatus connectable to the Internet comprising:

an apparatus body including connecting means for connecting the communication apparatus to the Internet; and

a storage device capable of being detachably attached to the apparatus body, or portable as a unit from the apparatus body;

the storage device being capable of storing at least either of information being a subject for communications and setting information necessary for the Internet connection, as information on the Internet, and including:

display means for displaying stored information; and

input means for subjecting the information displayed on the display means, to an editing manipulation,

the connection means of the apparatus body performing communications through the Internet utilizing the information on the Internet as stored in the storage device.

In accordance with the invention, the communication apparatus connectable to the Internet, such as the Internet facsimiles, includes the apparatus body and the storage device. The storage device is capable of storing at least either of the information being the subject for communications and the setting information necessary for the Internet connection, as the information on the Internet, and it is removably settable on the apparatus body or is portable as the unit separate from the apparatus body. The storage device is furnished with the display means for displaying stored information, and the input means for subjecting the information displayed on the display means, to the editing manipulation. The apparatus body is furnished with the connection means for performing the communications through the Internet by utilizing the information on the Internet as stored in the storage device, so that when the storage device is attached to the apparatus body, the communications of the Internet facsimile or the like can be performed by utilizing the information on the Internet as stored in the storage device.

When the storage device is removed from the apparatus body, the secret of the stored information can be reliably kept. The information stored in the storage device can be subjected to the editing manipulation, such as new input or revision, by using the display means and the input means, so that even when the storage device is not attached to the apparatus body, the stored personal information necessary for the Internet connection, and so forth can be subjected to reading, the revision and the new input. The information being the subject for the communications, such as any of various information items obtained by the communications with the storage device attached to the apparatus body, or a received mail item, can be read or subjected to a simple editing process by displaying the information on the display means of the storage device removed from the apparatus body. Further, in a state where the storage device is removed from the apparatus body, a so-called “off-line operation” can be performed for creating mail to-be-transmitted anew or performing editing or the like process.

In accordance with the invention, in the communication apparatus connectable to the Internet, such as the Internet facsimile, picture information for each individual person, personal information, etc. concerning the Internet can be stored in the storage device which can be detachably attached to the apparatus body or which is portable as the unit separate from the apparatus body, and the storage device is furnished with the display means and the input means such as a keyboard, whereby the information necessary for the connection to the Internet can be subjected to the editing such as new creation or revision, without occupying the communication apparatus. Moreover, the information received from the Internet and stored in the storage device can be read without occupying the communication apparatus. That is, the storage device may be attached to the communication apparatus during the actual communications only, and it can be used in the state where it is removed from the communication apparatus, at any other time. Thus, it is permitted to shorten a time period for which each user occupies the communication apparatus which is utilized by a plurality of users, and to share the single communication apparatus among the large number of users. Besides, in the case where a plurality of such communication apparatuses exist, each user can similarly use any of the communication apparatuses, merely by setting the storage device. When the storage device is removed from the apparatus body, the secret of the stored information can be reliably kept.

Besides, in the invention, it is preferable that the apparatus body further includes setting means for setting the information on the Internet as stored in the storage device, to be valid or invalid.

In accordance with the invention, when the storage device is attached to the apparatus body, the information on the Internet as stored in the storage device can be set valid or invalid by the setting means. When the stored information on the Internet is set invalid, the communications can be performed without utilizing the information, even in the state where the storage device is attached to the apparatus body. When the personal information for each user is set valid, the communications through the Internet can be performed in accordance with the information.

Besides, in accordance with the invention, the setting means can set the information to be invalid so as not to use the storage device, depending upon the application, taste, etc. of each user. Such a setting permits to perform the communications on the basis of the personal information of each user by using the storage device, and also permits to possess a setting and information common to a plurality of users, whereby the communication apparatus can be used by a larger number of users and for wider applications.

Besides, in the invention, it is preferable that the apparatus body further includes warning means responsive to a set content of the setting means and an attached state of the storage device;

the warning-means issues a warning for notifying that no storage device is attached, in the case where the information on the Internet is set valid by the setting means and where the storage device is not attached, and issues a warning for prompting the user to designate which of a plurality of storage devices is to be validated, in the case where the plurality of storage devices are attached; and

the warning means issues a warning for notifying that the storage device is invalidated, in the case where the information on the Internet is set invalid by the setting means and where the storage device is attached.

In accordance with the invention, when the setting by the setting means and the attached state of the storage device are contradictory, the warning is issued by the warning means. The warning means issues the warning for notifying that no storage device is attached, in the case where the information on the Internet is set valid by the setting means and where the storage device is not attached, and it issues the warning for prompting the user to designate which of the plurality of storage devices is to be validated, in the case where the plurality of storage devices are attached, so that the user's attention can be drawn so as to mount the valid storage device. The warning means issues the warning for notifying that the storage device is invalidated, in the case where the information on the Internet is set invalid by the setting means and where the storage device is attached, so that the invalidity of the storage device can be reliably notified to the user.

Besides, in accordance with the invention, the set content of the setting means and the existence or nonexistence of the storage device are checked, whereby an incorrect setting or a setting error can be prevented even in a situation where a large number of users share the single communication apparatus and where the set contents are variously altered.

Further, the invention provides a communication apparatus connectable to the Internet, comprising:

a separate unit which is separable from an apparatus body, and which is connectable so as to operate in association with the apparatus body,

the separate unit including storage means capable of storing at least either of information being a subject for communications and setting information necessary for the Internet connection, as information on the Internet; and

at least either of the apparatus body and the separate unit includes connection means for performing the communications through the Internet, utilizing the information on the Internet as stored in the storage means of the separate unit.

In accordance with the invention, the communication apparatus connectable to the Internet comprises the apparatus body and the separate unit. The separate unit is separable from the apparatus body and is connectable so as to operate in association with the apparatus body, and it the includes storage means capable of storing at least either of the information being the subject for the communications and the setting information necessary for the Internet connection, as the information on the Internet. At least either of the apparatus body and the separate unit includes the connection means for performing the communications through the Internet, by utilizing the information on the Internet as stored in the storage means of the separate unit, so that when the separate unit is connected with the apparatus body, the communications through the Internet can be performed by utilizing the information on the Internet as stored in the storage means. When the separate unit is removed from the apparatus body, the secret of the information stored in the storage means can be reliably kept.

Further, in accordance with the invention, in the communication apparatus connectable to the Internet, information items for each individual person, including the information being the subject for the Internet communications and the setting information necessary for the Internet connection, can be stored in the storage means of the separate unit which is separable from the apparatus body. Each of a plurality of users who use the communication apparatus can use this communication apparatus like a dedicated apparatus, merely in such a way that the separate unit storing the information for each individual person is connected to the apparatus body. Besides, in the case where a plurality of such communication apparatuses exist, each user can similarly use any of the communication apparatuses, merely by connecting the separate unit. When the separate unit is not connected to the apparatus body, the secret of the stored information can be reliably kept.

Besides, in the invention it is preferable that the communication apparatus further comprises:

a storage device capable of being detachably attached to the apparatus body or the separate unit, or portable as a separate unit,

the storage device is capable of storing at least either of information being a subject for communications and setting information necessary for Internet connection, as information on the Internet, and includes:

display means for displaying stored information; and

input means for subjecting the information displayed on the display means, to an editing manipulation, and

the connection means of the apparatus body performs the communications through the Internet utilizing the information on the Internet as stored in the storage device.

In accordance with the invention, the communication apparatus connectable to the Internet, such as the Internet facsimile, further comprises the storage device in addition to the apparatus body and the separate unit. The storage device is capable of storing at least either of the information being the subject for communications and the setting information necessary for the Internet connection, as the information on the Internet, and it can be detachably attached to the apparatus body or the separate unit or is portable as the separate unit. The storage device is furnished with the display means for displaying stored information, and the input means for subjecting the information displayed on the display means, to the editing manipulation. The apparatus body is furnished with the connection means for performing the communications through the Internet by utilizing the information on the Internet as stored in the storage device, so that when the storage device is attached to the apparatus body, the communications of the Internet facsimile or the like can be performed by utilizing the information on the Internet as stored in the storage device.

When the storage device is removed from the apparatus body or the separate unit, the secret of the stored information can be reliably kept. The information stored in the storage device can be subjected to the editing manipulation, such as new input or revision, by using the display means and the input means, so that even when the storage device is not attached to the apparatus body, the stored personal information necessary for the Internet connection, and so forth can be subjected to reading, the revision and the new input. The information being the subject for the communications, such as any of various information items obtained by the communications with the storage device attached to the apparatus body or the separate unit, or a received mail item, can be read or subjected to a simple editing process by displaying the information on the display means of the storage device removed from the apparatus body or the separate unit. Further, in a state where the storage device is removed from the apparatus body or the separate unit, a so-called “off-line operation” can be performed for creating mail to-be-transmitted anew or performing editing or the like process.

Besides, in accordance with the invention, the communication apparatus connectable to the Internet, such as the Internet facsimile, further comprises the storage device in addition to the apparatus body and the separate unit. Thus, picture information for each individual person, personal information, etc. concerning the Internet can be stored in the storage device which can be detachably attached to the apparatus body or the separate unit or which is portable as the separate unit, and the storage device is furnished with the display means and the input means such as a keyboard, whereby the information necessary for the connection to the Internet can be subjected to the editing such as new creation or revision, without occupying the communication apparatus. Moreover, the information received from the Internet and stored in the storage device can be read without occupying the apparatus body or separate unit of the communication apparatus. That is, the storage device may be attached to on the communication apparatus during the actual communications only, and it can be used in the state where it is removed from the communication apparatus, at any other time. Thus, it is permitted to shorten a time period for which each user occupies the communication apparatus which is utilized by a plurality of users, and to share the single communication apparatus among the large number of users. Besides, in the case where a plurality of such communication apparatuses exist, each user can similarly use any of the communication apparatuses, merely by setting the storage device. When the storage device is removed from the apparatus body or the separate unit, the secret of the stored information can be reliably kept.

Besides, in the invention, it is preferable that the apparatus body further includes setting means for setting the information on the Internet as stored in the separate unit or the storage device, to be valid or invalid.

In accordance with the invention, when the separate unit is connected to the apparatus body or when the storage device is attached to the apparatus body or the separate unit, the information on the Internet as stored in the separate unit or the storage device can be set valid or invalid by the setting means. When the stored information on the Internet is set invalid, the communications can be performed without utilizing the information, even in the state where the separate unit is connected to the apparatus body or where the storage device is attached to the apparatus body or the separate unit. When the personal information for each user is set valid, the communications through the Internet can be performed in accordance with the information.

Besides, in accordance with the invention, the setting means can set the information to. be invalid so as not to use the storage device, depending upon the application, taste, etc. of each user. Such a setting permits to perform the communications on the basis of the personal information of each user by using the storage device, and also permits to possess a setting and information common to a plurality of users, whereby the communication apparatus can be used by a larger number of users and for wider applications.

Besides, in the invention, it is preferable that the apparatus body further includes warning means responsive to a set content of the setting means and an attached state of the storage device,

the warning means issues a warning for notifying that no storage device is attached, in the case where the information on the Internet as stored in the storage device is set valid by the setting means and where the storage device is not attached, and issues a warning for prompting the user to designate which of a plurality of storage devices is to be validated, in the case where the plurality of storage devices are attached; and

the warning means issues a warning for notifying that the storage device is invalidated, in the case where the information on the Internet as stored in the storage device is set invalid by the setting means and where the storage device is attached.

In accordance with the invention, when the setting by the setting means and the attached state of the storage device are contradictory, the warning is issued by the warning means. The warning means issues the warning for notifying that no storage device is attached, in the case where the information on the Internet is set valid by the setting means and where the storage device is not attached on either the apparatus body or the separate unit, and it issues the warning for prompting the user to designate which of the plurality of storage devices is to be validated, in the case where the plurality of storage devices are attached, so that the user's attention can be drawn so as to mount the valid storage device. The warning means issues the warning for notifying that the storage device is invalidated, in the case where the information on the Internet is set invalid by the setting means and where the storage device is attached, so that the invalidity of the storage device can be reliably notified to the user.

Besides, in accordance with the invention, the set content of the setting means and the existence or nonexistence of the storage device are checked, whereby an incorrect setting or a setting error can be prevented even in a situation where a large number of users share the single communication apparatus and where the set contents are variously altered.

Besides, in the invention, it is preferable that in the case where the information on the Internet as stored in the separate unit and the information on the Internet as stored in the storage device are both set valid by the setting means, and where only either of the separate unit and the storage device is connected or attached, the connection means performs the communications through the Internet by utilizing the information on the Internet as stored in either of them.

In accordance with the invention, in the case where the information on the Internet as stored in the storage means of the separate unit and the information on the Internet as stored in the storage device are set valid by the setting means, the communications through the Internet are performed by utilizing the information of the separate unit on condition that the separate unit is connected and that the storage device is not attached, and by utilizing the information of the storage device on condition that the separate unit is not connected and that the storage device is attached, so the personal communications through the Internet can be performed merely by connecting or mounting either of them.

Besides, in accordance with the invention, in the case where the separate unit and storage device are set valid by the setting means beforehand, the communications through the Internet can be performed by utilizing the information of the separate unit on condition that the separate unit is connected and that the storage device is not attached, and by utilizing the information of the storage device on condition that the separate unit is not connected and that the storage device is attached.

Besides, in the invention, it is preferable that in the case where the information on the Internet as stored in the separate unit and the information on the Internet as stored in the storage device are both set valid by the setting means, and where the separate unit is connected, while the storage device is attached, the connection means performs the communications through the Internet by utilizing the information on the Internet as stored in that one of the separate unit and the storage device whose priority level is higher in accordance with preset priority levels.

In accordance with the invention, even in the case where the separate unit and the storage device storing the information items on the Internet are simultaneously connected or attached and where they are respectively set valid, the information for use in the communications through the Internet can be selected in accordance with the priority levels for the reason that these priority levels are preset.

Besides, in accordance with the invention, even in the case where the separate unit and the storage device storing the information items on the Internet are simultaneously connected or attached, the information for use in the communications through the Internet can be selected in accordance with the priority levels.

Besides, in the invention, it is preferable that the separate unit is a manipulation panel which can be detachably attached to the apparatus body, and with which a manipulating input for a communication function is possible in both an attached state and a detached state.

In accordance with the invention, the manipulation panel which is detachably attachable to the apparatus body, and with which the manipulating input for the communication function is possible in both the attached state and the detached state, is furnished with storage means or has the storage device attached thereon, whereby the information on the Internet can be stored, and the communications through the Internet can be performed by utilizing the stored information.

Besides, in accordance with the invention, the manipulation panel is made detachably attachable to the apparatus body and capable of the manipulating input for the communication function in both the attached state and the detached state, whereby the personal information on the Internet can be stored so as to perform the communications through the Internet.

Besides, in the invention, it is preferable that the separate unit is a slave set which can operate with the apparatus body being a master set.

In accordance with the invention, the separate unit is made the slave set which can operate with the apparatus body being the master set, and it is furnished with storage means or has the storage device attached thereto, whereby the information on the Internet can be stored, and the communications through the Internet can be performed by utilizing the stored information.

Besides, in accordance with the invention, the personal information on the Internet is stored in the slave set, whereby the communications through the Internet can be performed.

Further, the invention provides a program which causes a computer to function as any of the communication apparatuses described above.

In accordance with the invention, the general-purpose computer includes a storage device and a separate unit, and the personal information on the Internet is stored in the storage device and the separate unit, whereby the communications through the Internet can be performed.

Further, in accordance with the invention, the general-purpose computer, and the storage device and the separate unit are utilized, and the personal information items on the Internet are stored in the storage device and the separate unit, whereby each of a plurality of users can perform the communications through the Internet as if the communication apparatus were dedicated to him/her.

### BRIEF DESCRIPTION OF THE DRAWINGS

Other and further objects, features, and advantages of the invention will be more explicit from the following detailed description taken with reference to the drawings wherein:

FIG. 1 is a perspective view showing the outward construction of an I-FAX apparatus 1 which is an embodiment of the present invention;

FIG. 2 is a block diagram showing the electrical arrangement of a portion which functions as a master set 2 in the I-FAX apparatus 1 in FIG. 1;

FIG. 3 is a block diagram showing the electrical arrangement of a portion which functions as a slave set 3 in the I-FAX apparatus 1 in FIG. 1;

FIG. 4 is a front view showing the outward appearance of another example of the slave set 3 which is used in the I-FAX apparatus 1 in FIG. 1;

FIG. 5 is a diagram showing a system architecture in which the I-FAX apparatuses 1 as shown in FIG. 1 are connected to the Internet 100 as I-FAX apparatuses 101 to 104;

FIG. 6 is a perspective view showing the outward construction of an I-FAX apparatus 201 which is another embodiment of the invention;

FIG. 7 is a block diagram showing the schematic electrical arrangement of a portable storage device 202 shown in FIG. 6;

FIGS. 8A and 8B are diagrams each showing an example of a screen for setting which of storage devices is to be selected as the save area of information, on the I-FAX apparatus 201 shown in FIG. 6; and

FIG. 9 is a flow chart showing the steps of a process for properly using the storage devices in the I-FAX apparatus 201 shown in FIG. 6.

### DETAILED DESCRIPTION OF THE PREFERRED EMBODIMENTS

Now referring to the drawings, preferred embodiments of the invention are described below.

The present invention is applicable to any of communication apparatuses and information processing apparatuses connectable to the Internet, such as an Internet facsimile apparatus (hereinbelow, termed “I-FAX apparatus”) and an Internet-connection telephone set which can be connected to the Internet network directly or through ordinary PSTN (Public Switched Telephone Network), ISDN (Integrated Services Digital Network) or the like public network, but the I-FAX apparatus shall be described here by way of example.

By the way, in the connection to the Internet network, a transmission speed can be heightened by utilizing ADSL (Asymmetric Digital Subscriber Line) which is a kind of technique called “xSDL” for broadbanding a subscriber line connected to the PSTN. Besides, as a broadbanded communication line, it is possible to utilize a broadcasting cable such as CATV (CAble TeleVision) or to utilize an optical fiber such as FTTH (Fiber To The Home).

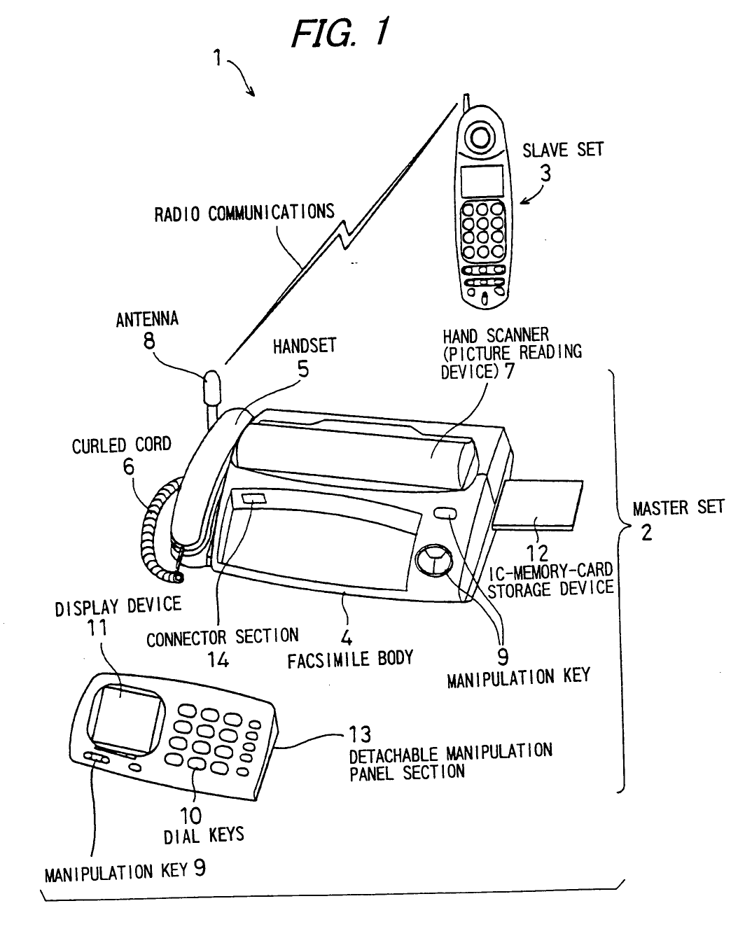

FIG. 1 shows in perspective the schematic outward construction of an I-FAX apparatus 1 as an embodiment of the invention. The I-FAX apparatus 1 can interpret HTML (Hyper Text Markup Language) in addition to conventional facsimile picture communications, so that it can receive the Internet pictures of Web pages etc. and can transmit and receive the information items of pictures, texts etc. by electronic mail. This I-FAX apparatus 1 has a master set 2, and a slave set 3 which is connected to the master set 2 over radio communications. Besides, one or more slave sets 3 can be wire-connected to the I-FAX apparatus 1, and it/they can cordlessly talk with the master set 2 of the I-FAX apparatus 1 and the exterior thereof. Moreover, the slave sets 3 can be connected to the Internet through the master set 2.

The master set 2 includes a facsimile body 4 which is the apparatus proper, a handset 5 which is connected to the facsimile body 4 by a curled cord 6, a hand scanner 7 which is a picture reading unit, an antenna 8, a key manipulation section 9, dial keys 10, a display device 11, an IC-memory-card storage device 12, etc.

A detachable manipulation panel section 13 includes some of the manipulation keys 9 of the master set 2, the dial keys 10 and the display device 11, and it is a device which is detachably attached to the facsimile body 4. Besides, a chargeable battery necessary for operations is mounted in the detachable manipulation panel section 13, together with a memory being storage means. When the detachable manipulation panel section 13 is attached to the facsimile body 4, the battery is charged through a connector section 14.

The storage devices of the detachable manipulation panel section 13 and slave set 3, and the IC-memory-card storage device 12 are portable storage devices which are units that can be detachably attached to the facsimile body 4, or units that are separate from the master set 2, and in which personal information items and Internet information items for each individual person are stored. The IC-memory-card storage device 12 can also be made free to be attached to and detached from the slave set 3 or the detachable manipulation panel section 13.

Here, the “personal information” is information on the Internet connection of each user. More specifically, the personal information signifies the mail addresses, DNS (Domain Name System) codes and ID codes of the users, servers to which the users connect the I-FAX apparatus 1, the destination addresses of mail destinations etc., a collection of URLs which are called “favorites”, “bookmarks” or the likes and which have been individually registered by the users, various histories, and so forth, and at least one of them is recorded as the personal information. Besides, the “Internet information for each individual person” is information which has been individually accepted from the Internet by the users. More specifically, the Internet information for each individual person signifies pictures which are handled on the Internet, and which include the pictures of the Internet, those of electronic mail items and those of inputted electronic mail items, and so forth. Incidentally, the pictures being the Internet information for each individual person may be stored in the bitmap format, or they may well be stored as described by the HTML.

In the case where the I-FAX apparatus 1 is to be connected with the Internet through the public network or the broadbanded communication line, an ISP (Internet Service Provider) needs to intervene for the connection. It is also possible that the individual users make contracts with ISPs and acquire personal accounts for the connections, so information items necessary for the connections to the respective ISPs are stored as the personal information items beforehand.

The IC memory card 12 is an IC memory card which conforms to JEIDA (Japan Electronic Industry Development Association) or PCMCIA (Personal Computer Memory Card International Association). Owing to the use of the IC memory card conforming to the above association, data stored in the IC-memory-card storage device 12 can be read out also by another equipment, such as personal computer, which can use this IC memory card. Incidentally, any of CompactFlash (registered trademark), an SD card, or the like which is extensively used for digital cameras etc. can be used as the IC memory card 12.

Besides, the detachable manipulation panel section 13 includes some of the manipulation keys 9, the dial keys 10 and the display device 11. Therefore, even in a state where the section 13 is detached from the facsimile body 4, the information for each individual person concerning the Internet as stored in the internal storage means can be subjected to supplementation, revision, etc. as the separated unit. On that occasion, the user can subject the information to the supplementation, revision, etc. reliably while ascertaining it on the display device 11. Further, since the slave set 3 to be detailed later has a display device, the user can perform the supplementation, revision, etc. of the information for each individual person concerning the Internet while ascertaining the information on the display device, by manipulating the slave set 3.

Such information for each individual person concerning the Internet can be stored in any of the detachable manipulation panel section 13, slave set 3 and IC-memory-card storage device 12, in other words, the portable storage device. Therefore, each user can carry the storage device in which the information for each individual person is stored, and the secret of the information for each individual person can be kept. Moreover, in the case where the I-FAX apparatus 1 are jointly used by a plurality of persons, each user mounts the portable storage device on, for example, the I-FAX apparatus 1 at the use thereof, whereby he/she can use the shared I-FAX apparatus 1 as if it were an apparatus dedicated to him/her.

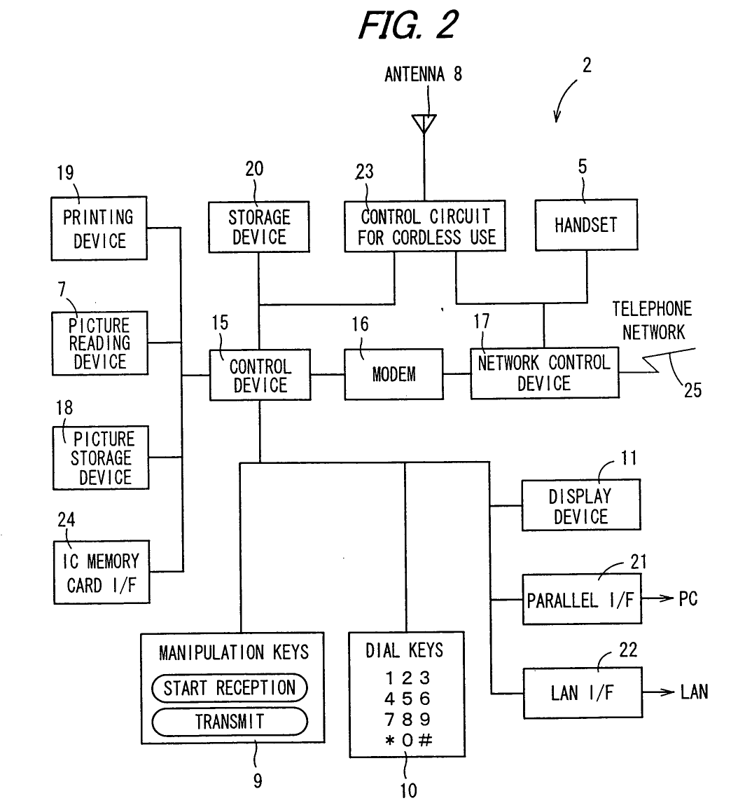

FIG. 2 shows the schematic electrical arrangement of the master set 2. The master set 2 is constructed including a control device 15, a modem 16, a network control device 17, a picture storage device 18, a printing device 19, the picture reading device 7, a storage device 20, the manipulation keys 9, the dial keys 10, the handset 5, the display device 11, a parallel I/F 21, a LAN I/F 22, a control circuit for cordless use 23, the antenna 8, and an IC memory card I/F 24. Incidentally, “I/F” is short for “interface”. “LAN” is short for “local area network”. Besides, the detachable manipulation panel section 13 in FIG. 1 is assumed to be attached to the facsimile body 4 and to be electrically connected through the connector section 14. The IC memory card 12 in FIG. 1 is detachably attached to the IC memory card I/F 24.

The master set 2 of the I-FAX apparatus 1 is connected to a telephone network 25 through the network control device 17. The network control device 17 monitors the situation of the telephone network 25, and it changes-over this network onto the side of the modem 16, the side of the handset 5 and the side of the control circuit for cordless use 23.

The control device 15 serves to control the operation and functions of the whole I-FAX apparatus 1. It determines the operation of the whole I-FAX apparatus 1 and gives commands, and also issues an displaying instruction to the display device 11, on the basis of information items such as input information items from the manipulation keys 9 and dial keys 10, information items indicating statuses from the various units or devices, and signals from the telephone network 25, conjointly with programs stored in the storage device 20. Besides, it takes charge of compression for shortening the transmission time period of picture information, and expansion for resuming a compressed picture signal into original pixel string information. The modem 16 modulates the digital signal of a read picture into an analog signal suited to the telephone network 25, and it demodulates the analog signal of a picture received from the telephone network 25, into a digital signal for printing.

The printing device 19 is a unit for printing a received or read picture, and any of a thermal scheme, an electrophotographic scheme, an ink jet scheme, etc. is often employed therefor. The picture reading device 7 is a device for reading an original to-be-transmitted or -duplicated, and any of a reduction reading scheme based on the combination of a lens and a CCD line sensor, a close-contact sensor scheme employing a rod lens array, etc. is employed therefor. The picture storage device 18 is a unit for storing a read picture and a received picture. The inclusion of this unit makes possible a large number of complicated functions, for example, the transfer and multiple addressing of a received picture, a delayed delivery service at the exhaustion of paper, and memory transmission.

The manipulation keys 9 and the dial keys 10 are units which serve for the user to input information or an instruction to the I-FAX apparatus 1. The display device 11 is a unit for displaying information or making guidance to the user.

The control circuit for cordless use 23 is a circuit for controlling the slave set 3, and it includes, for example, a tuner which operates to search for a communication path for connection with the slave set 3, to establish the connection and to transmit and receive electric waves. The antenna 8 transmits and receives electric waves for communications with the slave set 3.

Besides, the detachable manipulation panel section 13 shown in FIG. 1 has the storage device 20 and picture storage device 18 of the master set 2, and a device taking charge of some of the functions of the control device 15.

The I-FAX apparatus 1 includes the three sorts of interfaces which permit communications with the Internet. They are a talking path with the telephone network 25, the parallel I/F 21 being an interface with to a personal computer (PC), and the LAN I/F 22 being an interface to a LAN.

The following methods are mentioned by way of example as a connection method for the communications with the Internet: A method in which the ordinary facsimile transmission and reception are performed by the connection with the telephone network 25, and the communications with the Internet are performed through either of the parallel I/F 21 and the LAN I/F 22. A method in which all the communications of the ordinary facsimile transmission and reception, the communications with the Internet, etc. are performed by the connection with the telephone network 25. However, the connection method for the communications with the Internet need not be the above method, and the I-FAX apparatus 1 need not always include all of the three interfaces. Besides, although the interface to the PC is the parallel I/F 21 in FIG. 2, it need not be the parallel I/F. It is also possible to utilize any of a serial I/F, infrared rays, radio electric waves, etc.

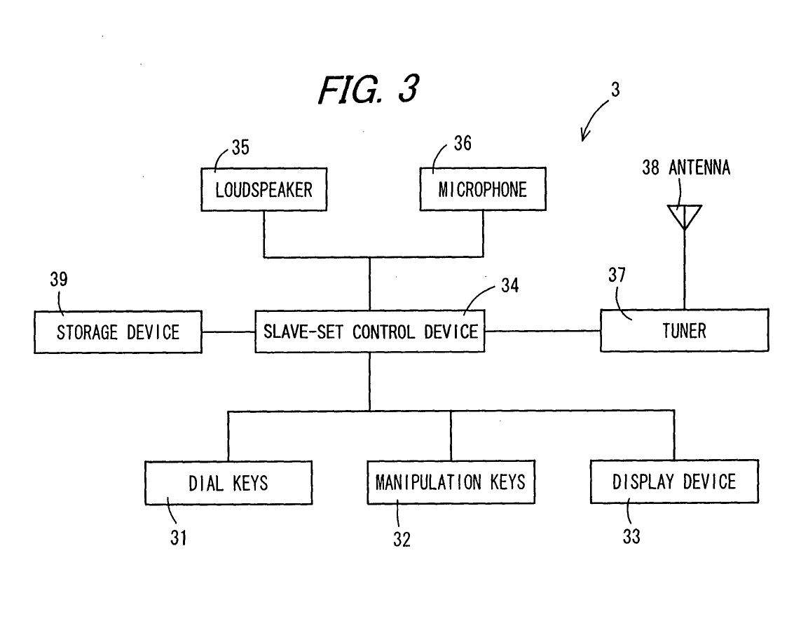

FIG. 3 shows the schematic electrical arrangement of the slave set 3. The slave set 3 is constructed including slave-set dial keys 31, slave-set manipulation keys 32, a slave-set display device 33, a slave-set control device 34, a slave-set loudspeaker 35, a slave-set microphone 36, a slave-set tuner 37, a slave-set antenna 38 and a slave-set storage device 39. Although not shown in the figure, a chargeable battery which serves as a power source necessary for operations is mounted in the slave set 3, and it is charged when set on a charging stand. As described before, it is also possible to make the IC memory card 12 mountable on the slave set 3.

The construction of the slave set 3 is substantially the same as that of the master set 2 in FIG. 2 except that the interface of signals with the exterior is restricted to communications based on electric waves from the slave-set antenna 38, and that an input/output device for pictures is not disposed. Further, since the whole slave set 3 is portable, the slave-set dial keys 31, slave-set manipulation keys 32, slave-set display device 33, slave-set loudspeaker 35, slave-set microphone 36, etc. have small geometries suited to the portability. The slave-set control device 34 has both the functions of controlling the operation of the whole slave set 3 and setting a radio channel necessary for communications with the master set 2. Either a digital scheme or an analog scheme may be used as means for the communications with the master set 2.

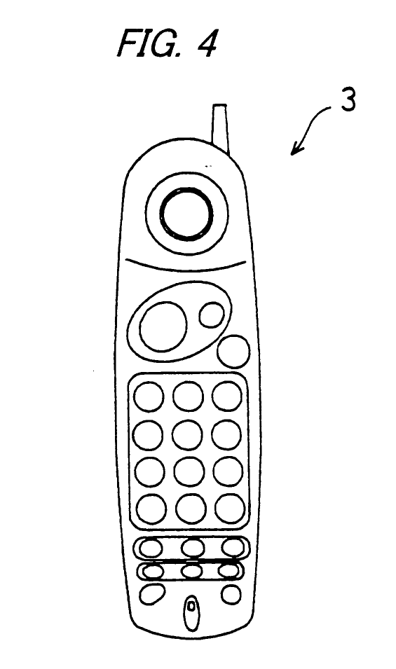

FIG. 4 shows the outward construction of another example which is usable as the slave set 3. Although the example does not include the slave-set display device 33 as in the outward appearance of the slave set 3 shown in FIG. 1, it includes the slave-set storage device 39, in which the personal information, etc. of the user to use the slave set 3 may be stored. It is also possible to make the IC memory card 12 mountable on the example.

The slave set 3 can be connected to the Internet by employing the slave-set dial keys 31, slave-set manipulation keys 32 and slave-set display device 33. In the connection from the slave set 3 to the Internet, the information for each individual person concerning the Internet as stored in the slave set 3 is used. Received data, etc. may be stored in the slave set 3, or may well be stored in the detachable manipulation panel section 13 or IC memory card 12 which is the portable storage device. Besides, in FIG. 1, the IC memory card 12 is associated with the master set 2 as the portable storage device, but it need not be associated with the master set 2 as the portable storage device.

When a picture or the like is to be transmitted or received by the I-FAX apparatus 1, at least one of the detachable manipulation panel section 13, slave set 3 and IC memory card 12 which operate as the portable storage devices is set or activated. In the case where none of the storage devices is set or activated, a warning for notifying the state is issued. Besides, in the case where two or more of the portable storage devices are set or activated, a warning is given to the user, and the user is dialogically prompted to designate which of the portable storage devices the picture or the like is to be stored in. Moreover, in the presence of the plurality of portable storage devices, the priority levels thereof for storing the picture or the like may well be set beforehand. In this manner, in the connection to the Internet, the personal information on the Internet is stored in the portable storage devices, the information received from or transmitted to the Internet is stored in any of the portable storage devices, and the user detaches the storage device and possesses it by himself/herself. The secret of the information for each individual person concerning the Internet can be reliably kept by storing the personal information as stated above.

When the information items for each individual person concerning the Internet are stored in the portable storage devices as described above, some of the users might conversely undergo such an inconvenience that business becomes complicated. Accordingly, the I-FAX apparatus 1 may well be permitted to be so set that a storage device for use in Internet communications is limited only to the storage device 20 being the common portion of the facsimile body 4, and that the information items for each individual person concerning the Internet are not stored in the respective storage devices.

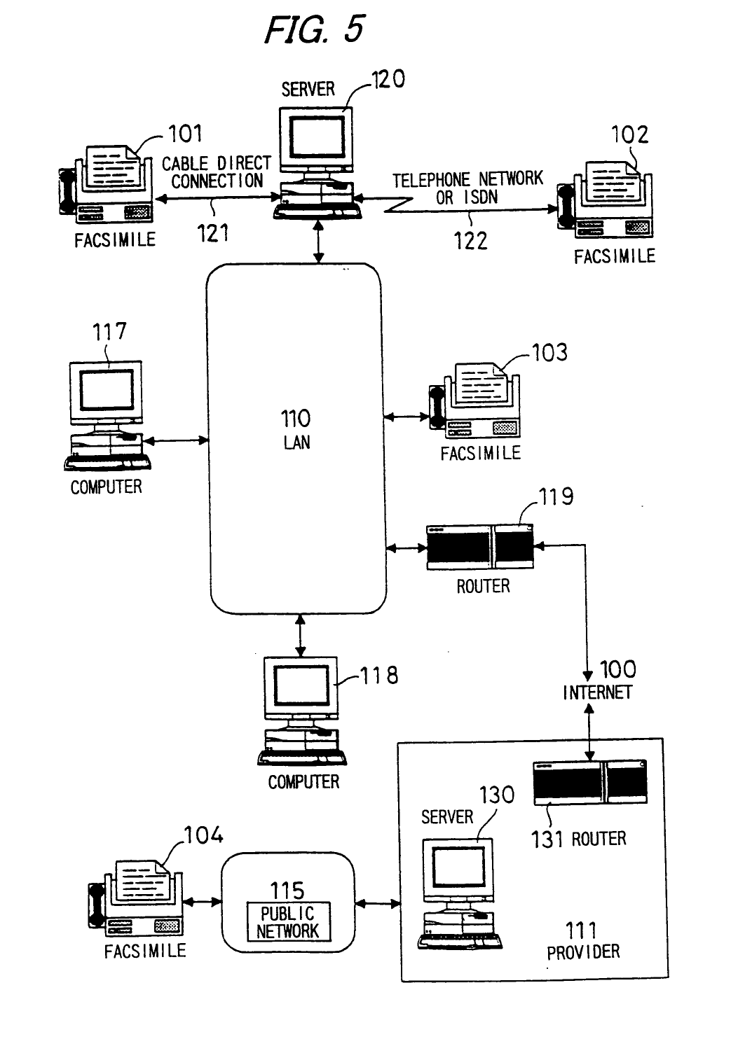

FIG. 5 shows the outlines of methods in which the I-FAX apparatuses 1 as shown in FIG. 1 are connected to the Internet 100 as I-FAX apparatuses 101 to 104. Shown in FIG. 5 are the method in which the facsimiles, etc. are connected to the Internet 100 from a LAN 110 such as enterprise LAN often constructed for business use, through an Internet service provider usually abbreviated to ISP (hereinbelow, simply termed “provider”) 111, and the method in which the facsimile to be used by individuals is connected from a public network 115 to the Internet 100 through a provider 111. The illustrated circuit arrangements merely exemplify layouts for connecting the facsimile apparatuses to the Internet 100, and the connections of the I-FAX apparatus 1 of this embodiment to data communication lines are not restricted to the illustrated ones.

In case of employing the LAN 110, personal computers 117, 118, etc. which are the terminal devices of clients are connected on the LAN 110, and they are connected from the LAN 110 to the Internet 100 via a router 119. Also, a server computer 120 is connected to the LAN 110, and received text data, facsimile pictures, voices or the like communication data for the clients managed by the server computer 120 are temporarily stored in this server computer 120.

The I-FAX apparatus 101 is directly connected from an interface corresponding to the parallel I/F 21 shown in FIG. 2, to the server computer 120 by a cable 121. The I-FAX apparatus 102 is connected to the server computer 120 through a public network 122 which is a telephone network or ISDN. This I-FAX apparatus 102 can understand PPP (Point-to-Point Protocol) for talking with the server computer 120 through the public network 122, and create signals therefor. The talk is established by connecting the I-FAX apparatus 102 to the public network 122 including the ISDN, through a device corresponding to the network control device 17 shown in FIG. 2. The I-FAX apparatus 103 is directly connected to the LAN 110 from an interface corresponding to the LAN I/F 22 shown in FIG. 2. The illustrated circuit arrangements for connecting the IFAX apparatuses 101 to 103 to the Internet 100 are mere examples, and other circuit arrangements may well be employed.

The I-FAX apparatus 104 are connected to the Internet 100 by the method which individuals usually employ. Users make contracts with the provider or ISP 111, and the I-FAX apparatus 104 is connected with a server computer 130 installed by the provider 111, through the public network 115 such as telephone network or ISDN. The provider 111 is connected to the Internet 100 through a router 131 so as to transmit or receive information to or from the Internet 100. Besides, on this occasion, the provider 111 stores the transmission/reception information of a client, for example, the I-FAX apparatus 104, in the server computer 130 managed by this provider 111.

In the case where the I-FAX apparatus 1 as shown in FIG. 1 is employed as the I-FAX apparatus 104, and where the single apparatus is shared by the plurality of users, the respective users can utilize different providers 111. The telephone Nos. of access points to be utilized for connections to the server computers 130 of the providers 111 with which the respective users made contracts, information items necessary for PPP connections, etc. are previously stored in the detachable manipulation panel section 13 or slave set 3 which is a separate unit, or in the IC memory card 12 which is to be attached to the separate unit. Thus, the I-FAX apparatus 104 can be readily connected to the Internet 100 by using such information items.

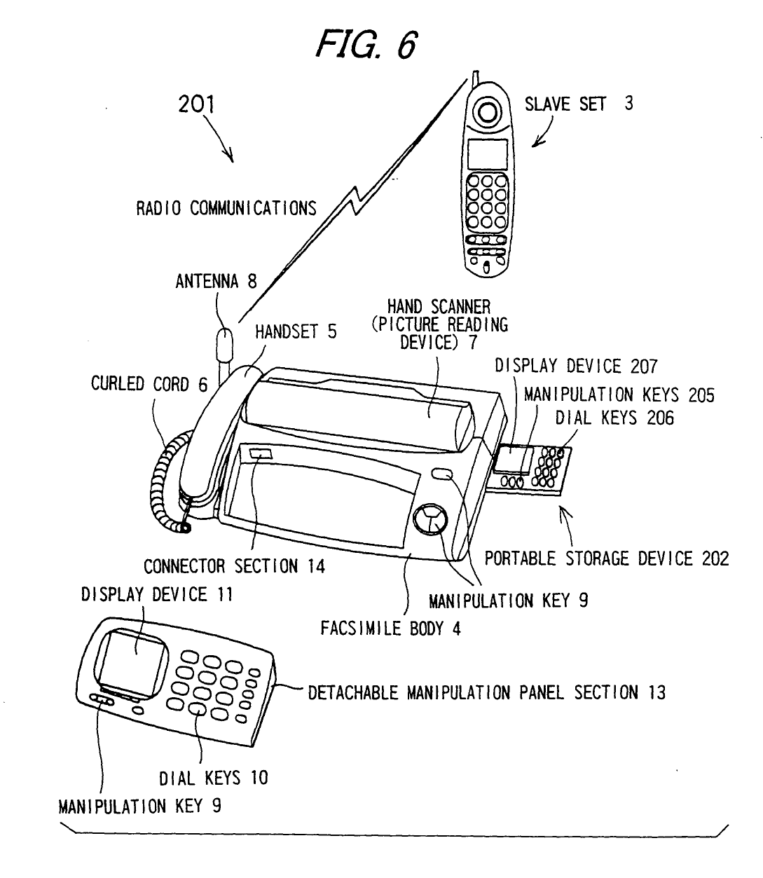

FIG. 6 shows in perspective the schematic outward construction of an I-FAX apparatus 201 as another embodiment of the invention. In this embodiment, portions corresponding to the I-FAX apparatus 1 shown in FIG. 1 are assigned the same reference numerals and shall not be repeatedly explained. A slave set 3 and a detachable manipulation panel section 13 can be operated as devices for storing personal information items on the Internet, as separate units. A plurality of such slave sets 3 each including a slave-set display device 33 or such detachable manipulation panel sections 13 each including a display device 11 can be connected while being changed-over, and a plurality of users possess the sets 3 or/and the sections 13 as their own separate units. When the separate unit is used in association with the I-FAX apparatus 201, each of the users can use the I-FAX apparatus 201 likewise to the apparatus dedicated to him/her, as in the case of the I-FAX apparatus 1 in FIG. 1. In this case, since the display device is included, it is possible to display the stored personal information and to input new personal information. Since a chargeable battery or the like is mounted in each of the separate units as a power source for operations, it is possible to display and edit information independently of the facsimile body 4.

In this embodiment, for the purpose of Internet connection, the personal information can be stored also in a portable storage device 202. The portable storage device 202 can include a connecting interface similar to that of the IC memory card 12 in FIG. 1, and it can be made mountable, not only on the facsimile body 4, but also on the slave set 3 and the detachable manipulation panel section 13. The I-FAX apparatus 201 in this embodiment can have the construction similar to that shown in FIGS. 2 and 3, and can be connected to the Internet 100 as shown in FIG. 5.

The portable storage device 202 in this embodiment is furnished with an input device such as simple keyboard including dial keys 206, manipulation keys 205, etc., and a display device 207, and it is internally furnished with a memory as storage means. The control device 15 shown in FIG. 2 stores parts concerning the personal information, in the detachable storage device directly connected, for example, the portable storage device 202, or the separate unit such as slave set 3 or detachable manipulation panel section 13, among the available storage devices. Since the portable storage device 202 is furnished with the input device and the display device 207, the contents of the information stored in the memory can be edited for revision, new creation, etc. by displaying them on the display device 207. In the case where information transmitted to or received from the Internet, and the personal information such as information necessary for the Internet connection are stored in the detachable portable storage device 202 in this manner, each user automatically possesses the personal information when he/she detaches the portable storage device 202 after use, so that a secret can be reliably kept.

In the case where, with the detachable manipulation panel section 13 attached to the facsimile body 4, the personal information is held stored in the storage device 20 shown in FIG. 2, it is possible as in the conventional facsimile apparatus to display the necessary personal information on the display device 11, and to revise or input anew information by manipulation keys 9 and dial keys 10. Even in a state where the detachable manipulation panel section 13 is separated from the facsimile body 4 so as to be operated alone, the information stored in the detachable manipulation panel section 13 can be displayed and edited in quite the same manner as in the attached state.

In this embodiment, the portable storage device 202 is also usable. Likewise to the detachable manipulation panel section 13, the portable storage device 202 is furnished with the dial keys 206, manipulation keys 205 and display device 207. Owing to these constituents, the portable storage device 202 is endowed with functions quite similar to those of the detachable manipulation panel section 13, so that it can execute editing processes such as the display of the personal information and the revision or new creation thereof. Regarding the portable storage device 202, however, the manipulation keys 206 must be made smaller than those 9 of the detachable manipulation panel section 13 with importance attached to portability. Besides, there may well be such a difference that the number of the manipulation keys 206 is smaller. Even in this case, the basic display contents and operating environment of the portable storage device 202 are made common to those of the detachable manipulation panel section 13 beforehand, whereby the processes such as display, revision and new creation can be equivalently executed.

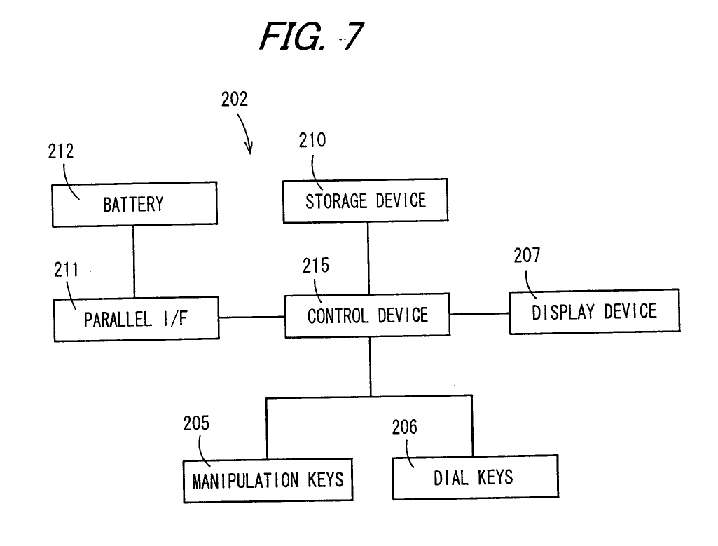

FIG. 7 shows the schematic electrical arrangement of the portable storage device 202 in simplified fashion. The portable storage device 202 includes the dial keys 206, manipulation keys 205 and display device 207 as described before. It further includes a storage device 210, a parallel I/F 211, a battery 212 and a control device 215. The battery 212 is of chargeable type, and it can also be charged in such a way that, when the parallel I/F 211 is attached to the IC memory card I/F 24 as shown in FIG. 2, so as to electrically connect the portable storage device 202, charging power is fed from the facsimile body 4. The chargeable secondary battery, however, may well be replaced with a primary battery such as element battery. A liquid crystal display (LCD) or the like can be used as the display device 207. Besides, the dial keys 206, manipulation keys 205 and display device 207 may well be replaced with a touch panel or the like so as to simultaneously input and display information.

Incidentally, the facsimile body 4 can also utilize the manipulation key 9 or the like as setting means for validating or invalidating information on the Internet as stored in the portable storage device 202. Owing to such setting means, in the case where the Internet information stored in the portable storage device 202 is set invalid when this portable storage device 202 has been attached to the facsimile body 4, communications can be performed without utilizing the stored information on the Internet, even in a state where the portable storage device 202 is held attached on the facsimile body 4. In the case where the Internet information is set valid, communications through the Internet can be performed in accordance with the personal information of each user.

The function of utilizing the Internet by storing information items for each individual person, necessitates to always prepare the portable storage devices 202 or the likes. Therefore, some users have their business complicated conversely and do not want to utilize the function. In such a case, the function can be easily avoided by changing settings so as to designate the storage device 20 in the facsimile body 4 for information in the case of utilizing the Internet.

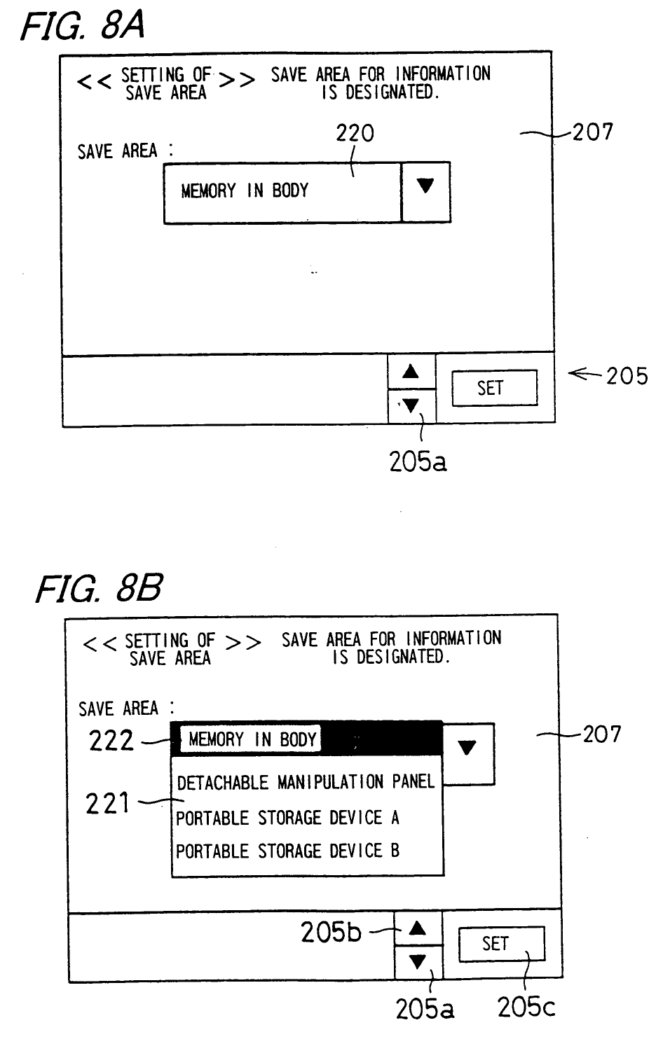

FIGS. 8A and 8B show examples of displays in the case of setting a save area on the facsimile body 4, and keys to be used for manipulations. FIG. 8A exemplifies a screen for setting the save area of personal information items such as mail and pages received from the Internet 100, while FIG. 8B exemplifies a screen for setting the save area in a menu form. In the display example of FIG. 8A, “Memory in body” being the storage device 20 in FIG. 2 is displayed as a default save area, within a dialog box 220 for inputting the save area. On the other hand, a pull-down menu 221 as shown in FIG. 8B is displayed by pressing the manipulation key 9 of the detachable manipulation panel section 13 or a downward arrow key 205a in the manipulation keys 205 of the portable storage device 202. In the display of the pull-down menu 221, the line 222 of designated “Memory in body” is displayed by changing a background color or the like. The line 222 is moved downwards by pressing a downward arrow key 205a, whereas the line 222 is moved upwards by pressing an upward arrow key 205b. When a set key 205c is pressed in the state where the color of a desired choice is changed as the line 222, the setting is stored in the storage device 20 of the facsimile body 4, and the display of FIG. 8A is resumed. On this occasion, however, the save area designated anew is displayed in the dialog box 220.

Here, the downward arrow key 205a, upward arrow key 205b and set key 205c of the manipulation keys 205, and the pull-down menu 221 are mere examples of realization methods. Since other keys, and another scheme for displaying setting candidates can also be employed, FIGS. 8A and 8B shall not restrict the realization methods of settings which are handled in the invention. Regarding information which is utilized in making the Internet connection, which of the storage devices is to be employed can be set likewise to the storage device of the save area. Alternatively, the storage device of the information can be designated simultaneously with the designation of the save area.

By the way, in FIG. 8B, the detachable manipulation panel section 13 is indicated by “Detachable manipulation panel”, and two of the portable storage devices 202 are distinguished by “Portable storage device A” and “Portable storage device B”. The two portable storage devices 202 corresponds to a case where the facsimile body 4 is provided with a plurality of IC memory card I/Fs 24, to which the two portable storage devices 202 can be attached. Besides, even in the case where only one portable storage device 202 can be attached to the facsimile body 4, the two portable storage devices 202 can be attached when the portable storage device 202 is made attachable to the separate unit such as slave set 3 or detachable manipulation panel section 13. In such a case, the two portable storage devices 202 can conform to an identical standard and be distinguished by the attaching positions thereof. Alternatively, the two portable storage devices 202 can conform to different standards and be distinguished by the standards.

The slave set 3 can also be included in the pull-down menu 221 as shown in FIG. 8B. When a plurality of slave sets 3 are simultaneously employed, which of the slave sets 3 is to be used as the save area can also be made selectable.

In order to operate the I-FAX apparatus 201, the user needs to set at least one of the portable storage device 202 and the detachable manipulation panel section 13. Therefore, in the case where neither of them is set, a warning is issued to the user. Warning means can be based on the sound of a handset 5, a buzzer or the like, or can utilize the flickering of light.

Besides, the detachable manipulation panel section 13 is required, not only for the processes of the personal information and the process of the connection to the Internet 100, but also for the manipulations of all the functions of the I-FAX apparatus 201. Therefore, it is also possible to issue a warning to the user in the case where the detachable manipulation panel section 13 is not connected to the facsimile body 4, without regard to the setting of the portable storage device 202. Further, in the case where both the portable storage device 202 and the detachable manipulation panel section 13 are set, or where the plurality of portable storage devices 202 are set, a warning is issued to the user, and it is dialogically prompted to designate which of the storage devices is used for validating information, or which of the storage devices information is to be stored in, whereupon the subsequent process is shifted to. An alternative method is such that the priority levels of the uses of the storage devices are set beforehand.

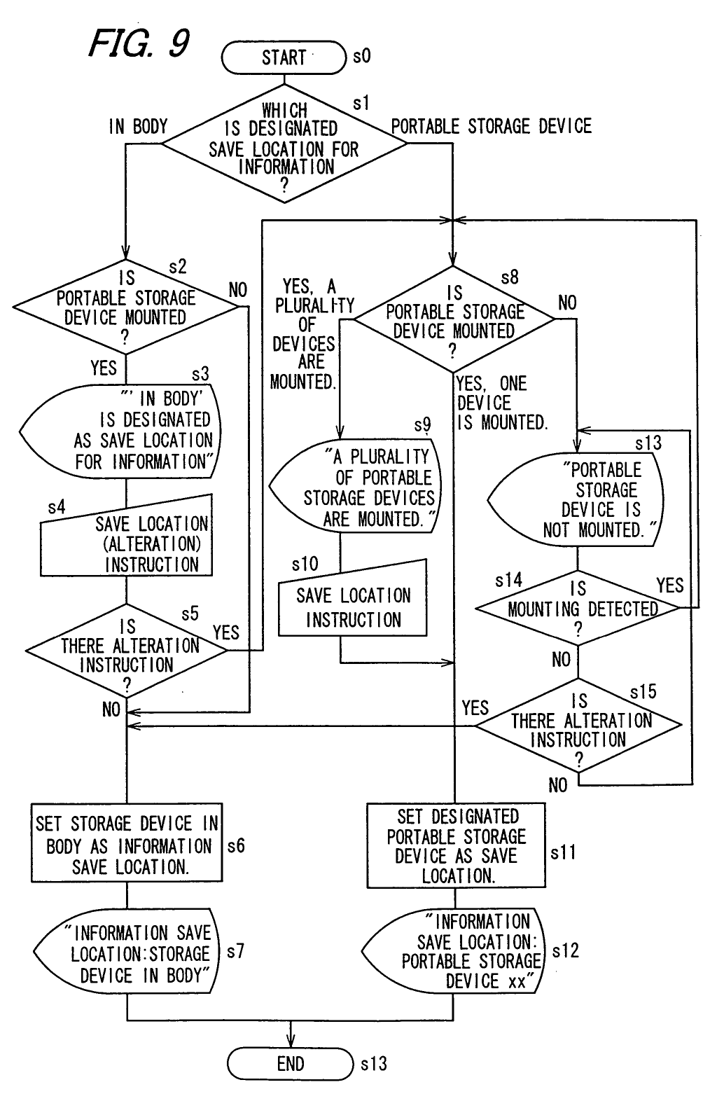

FIG. 9 shows in detail the steps of a process for properly using the storage devices. It is assumed that the save area for the personal information has been preset by the setting as described before. Accordingly, in the case where the personal information is required in the communicating process of the I-FAX apparatus 201, or where the personal information is subjected to the save process, the routine is started at a step s0, and the save location of the information is checked at a step s1. Processing at the step s1, et seq. is executed at the beginning after the turn-ON of a power source, in the case where the set contents as shown in FIGS. 8A and 8B have been altered, or in the case where the detachable manipulation panel section 13 or the portable storage device 202 has been attached or detached. In any other case, information is read or written in accordance with the stored set contents.

When it is judged by the check of the step s1 that “In body” is set, whether or not the portable storage device 202 is attached is checked at a step s2. Subject to the judgment that the portable storage device 202 is attached, a display to the effect that “In body” is set is presented at a step s3 for the reason that there is the possibility of a setting error, whereby a confirmation is made in consideration of the possibility of the setting error. At a step s4, the instruction of altering the save location after the confirmation of the display can be accepted. At a step s5, the alteration instruction from the user is waited. Whether or not there is the alteration instruction can be judged by, for example, waiting the lapse of a predetermined time period.

Subject to the judgment at the step s2 that the portable storage device 202 is not attached, or the judgment at the step s5 that there is not the alteration instruction, the storage device 20 in the facsimile body 4 is set valid as the information save location at a step s6. At the next step s7, a display is presented so that information may be stored in the facsimile body 4, or that the information in the facsimile body 4 may be read out and used.

Subject to the judgment at the step s1 that “Portable storage device” is set as the save area, or the judgment at the step s5 that there is the alteration instruction, whether or not the portable storage device 202 is attached is judged at a step s8. When it is judged by the check of the step s8 that the plurality of portable storage devices 202 are attached, a warning display to the effect that the plurality of portable storage devices 202 are attached is presented at a step s9 for the reason that there is the possibility of a setting error, whereupon an instruction from the user is waited. When an instruction for the save location is received at a step s10, a step s11 is shifted to. The step s11 is shifted to also when it is judged at the step s8 that only one portable storage device 202 is attached. At the step s11, the designated portable storage device 202 is set valid as the save location. At the next step s12, a display is presented so that information may be stored in the portable storage device 202, or that the information in the portable storage device 202 may be read out and used.

When it is judged at the step s8 that the portable storage device 202 is not attached, the setting is invalid. At a step s13, therefore, a warning display to the effect that the portable storage device 202 is not attached is presented, whereupon the mounting of the portable storage device 202 or the alteration of the storage location is waited. At a step s14, whether or not the mounting of the portable storage device 202 is detected is judged. When the mounting is detected, the routine returns to the step s8 so as to execute the processing which corresponds to the number of attached devices. When the mounting of the portable storage device 202 is not detected at the step s14, whether or not there is an alteration instruction from the user is judged at a step s15. When there is not the alteration instruction, the routine returns to the step s13. Subject to the judgment at the step s15 that there is the alteration instruction, the routine proceeds to the step s6. When the step s7 or the step s12 is ended, the routine is ended at a step s16.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication apparatus connectable to the Internet comprising:
an apparatus body including connecting means for connecting the communication apparatus to the Internet; and
a storage device capable of being detachably attached to the apparatus body, or portable as a unit from the apparatus body;
the storage device being capable of storing at least either of information being a subject for communications and setting information necessary for the Internet connection, as information on the Internet, and including:
display means for displaying stored information; and
input means for subjecting the information displayed on the display means, to an editing manipulation,
the connection means of the apparatus body performing communications through the Internet utilizing the information on the Internet as stored in the storage device.

2. The communication apparatus of claim 1, wherein the apparatus body further includes setting means for setting the information on the Internet as stored in the storage device, to be valid or invalid.

3. The communication apparatus of claim 1, wherein the apparatus body further includes warning means responsive to a set content of the setting means and an attached state of the storage device;
the warning means issues a warning for notifying that no storage device is attached, in the case where the information on the Internet is set valid by the setting means and where the storage device is not attached, and issues a warning for prompting the user to designate which of a plurality of storage devices is to be validated, in the case where the plurality of storage devices are attached; and
the warning means issues a warning for notifying that the storage device is invalidated, in the case where the information on the Internet is set invalid by the setting means and where the storage device is attached.

4. A communication apparatus connectable to the Internet, comprising:
a separate unit which is separable from an apparatus body, and which is connectable so as to operate in association with the apparatus body,
the separate unit including storage means capable of storing at least either of information being a subject for communications and setting information necessary for the Internet connection, as information on the Internet; and
at least either of the apparatus body and the separate unit includes connection means for performing the communications through the Internet, utilizing the information on the Internet as stored in the storage means of the separate unit.

5. The the communication apparatus of claim 4, further comprising:
a storage device capable of being detachably attached to the apparatus body or the separate unit, or portable as a separate unit,
the storage device being capable of storing at least either of information being a subject for communications and setting information necessary for Internet connection, as information on the Internet, and including:
display means for displaying stored information; and
input means for subjecting the information displayed on the display means, to an editing manipulation, and
the connection means of the apparatus body performing the communications through the Internet utilizing the information on the Internet as stored in the storage device.

6. The communication apparatus of claim 5, wherein the apparatus body further includes setting means for setting the information on the Internet as stored in the separate unit or the storage device, to be valid or invalid.

7. The communication apparatus of claim 6, wherein the apparatus body further includes warning means responsive to a set content of the setting means and an attached state of the storage device,
the warning means issues a warning for notifying that no storage device is attached, in the case where the information on the Internet as stored in the storage device is set valid by the setting means and where the storage device is not attached, and issues a warning for prompting the user to designate which of a plurality of storage devices is to be validated, in the case where the plurality of storage devices are attached; and
the warning means issues a warning for notifying that the storage device is invalidated, in the case where the information on the Internet as stored in the storage device is set invalid by the setting means and where the storage device is attached.

8. The communication apparatus of claim 6, wherein in the case where the information on the Internet as stored in the separate unit and the information on the Internet as stored in the storage device are both set valid by the setting means, and where only either of the separate unit and the storage device is connected or attached, the connection means performs the communications through the Internet by utilizing the information on the Internet as stored in either of them.

9. The communication apparatus of claim 6, wherein in the case where the information on the Internet as stored in the separate unit and the information on the Internet as stored in the storage device are both set valid by the setting means, and where the separate unit is connected, while the storage device is attached, the connection means performs the communications through the Internet by utilizing the information on the Internet as stored in that one of the separate unit and the storage device whose priority level is higher in accordance with preset priority levels.

10. The communication apparatus of claim 4, wherein the separate unit is a manipulation panel which can be detachably attached to the apparatus body, and with which a manipulating input for a communication function is possible in both an attached state and a detached state.

11. The communication apparatus of claim 4, wherein the separate unit is a slave set which can operate with the apparatus body being a master set.

12. A program which causes a computer to function as any of the communication apparatus of claim 1.

13. A program which causes a computer to function as any of the communication apparatus of claim 4.
